(19) United States
(12) Patent Application Publication
(10) Pub. No.: US 2017/0323529 A1
(43) Pub. Date: Nov. 9, 2017

(54) GAMING SYSTEM AND METHOD OF USING THE SAME

(71) Applicant: Turbo Gaming, LLC, Las Vegas, NV (US)

(72) Inventors: Fred Berger, Las Vegas, NV (US); Gary Gundersen, Henderson, NV (US)

(21) Appl. No.: 15/148,679

(22) Filed: May 6, 2016

(51) Int. Cl. G07F 17/32

(52) U.S. Cl. CPC G07F 17/3293; G07F 17/3211

(57) ABSTRACT

A system and method for conducting a casino game based on a number of same-suited cards. Players place a mandatory 9-card wager on red or black synonymous with Diamonds/Hearts and Spades/Clubs, respectively. Optional 3-card wagers (community cards), 6-card wagers (player cards) and 9-card bonus wagers (community cards+player cards) are available. After the placement of the mandatory 9-card wager and optional wagers, three community cards are dealt or displayed and then players have option to fold or place a play wager. Each player is then dealt or displayed six player cards. The nine total cards are then evaluated to determine if players hold three or more same-suited cards of the color selected by the player with the mandatory 9-card wager. Similarly, the optional 3-card, 6-card and 9-card bonus wagers require at least 2 flush cards, 3 flush cards and 5 flush cards, respectively, to support a wager payout.

### FIELD OF THE INVENTION

The embodiments of the present invention relate to a gaming system for conducting a casino game premised on playing card suits.

### BACKGROUND

Gaming continues to grow throughout the United States. While poker and blackjack dominate the table-game and online gaming space, there remains a large segment of players that do not prefer poker or blackjack.

Thus, it would be advantageous to develop casino games premised on themes which also include attractive payouts. Advantageously, the casino games developed should be suitable for both live and electronic formats.

### SUMMARY

The embodiments of the present invention are directed to a system and method for conducting a casino game based on a number of same-suited cards held by players. In one embodiment, the players have the option to select and place a mandatory 9-card wager on red or black synonymous with Diamonds/Hearts and Spades/Clubs, respectively. An optional 3-card wager (community cards), 6-card wager (player cards) and 9-card bonus wager (community cards+player cards) are available. After the placement of the mandatory 9-card wager and optional wagers, three community cards are dealt or displayed and then players have option to fold or place a play wager. Each player is then dealt or displayed six player cards. The nine total cards (three community cards and six player cards) are then evaluated to determine if any player holds three or more same-suited cards (i.e., flush) within the color selected by the player with the mandatory 9-card wager. In one embodiment, the mandatory 9-card wager and play wager push if the player holds three same-suited cards in the selected color and even money if the player holds four or more same-suited cards in the selected color. A pay table is used to payout winning bonus wagers.

In an electronic format, a player or players play against a stored pay table via a gaming device, such as a standalone gaming machine, gaming machine network, smartphone, tablet or computer. A processor, user interface, memory and display facilitate play via the gaming device as set forth in great detail below.

Other variations, embodiments and features of the present invention will become evident from the following detailed description, drawings and claims.

### BRIEF DESCRIPTION OF THE DRAWINGS

FIG. 1 illustrates a block diagram of components of an electronic gaming device for conducting a game according to the embodiments of the present invention;

FIG. 2 illustrates a block diagram of a wireless network system accessible by mobile devices for conducting a game according to the embodiments of the present invention;

FIG. 3 illustrates a block diagram of a wireless network system accessible by mobile devices for conducting a game according to the embodiments of the present invention;

FIG. 4 illustrates an exemplary table layout template according to the embodiments of the present invention;

FIG. 5 illustrates a flow chart detailing one methodology for conducting a live casino game according to the embodiments of the present invention;

FIG. 6 illustrates a flow chart detailing one methodology for conducting an electronic casino game according to the embodiments of the present invention; and

FIGS. 7A and 7B illustrate exemplary hands for evaluation according to the embodiments of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

Those skilled in the art will recognize that the embodiments of the present invention involve both hardware and software elements which portions are described below in such detail required to construct and operate a game method and system according to the embodiments of the present invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.), or an embodiment combining software and hardware. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), and optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied thereon, for example, in baseband or as part of a carrier wave. Such a propagated signal may take any variety of forms, including, but not limited to, electromagnetic, optical, or any suitable combination thereof. A computer readable signal medium may be any computer readable medium that is not a computer readable storage medium and that can communicate, propagate, or transport a program for use by or in conjunction with an instruction execution system, apparatus, or device.

Program code embodied on a computer readable medium may be transmitted using any appropriate medium, including but not limited to wireless, wireline, optical fiber cable, RF and the like, or any suitable combination of the foregoing.

Computer program code for carrying out operations for aspects of the present invention may be written in any combination of one or more programming languages, including an object oriented programming language such as Java, Smalltalk, C++ or the like or conventional procedural programming languages, such as the “C” programming language, AJAX, PHP, HTML, XHTML, Ruby, CSS or similar programming languages. The programming code may be configured in an application, an operating system, as part of a system firmware, or any suitable combination thereof. The programming code may execute entirely on the user's computer, partly on the user's computer, as a standalone software package, partly on the user's computer and partly on a remote computer or entirely on a remote computer or server as in a client/server relationship sometimes known as cloud computing. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagrams. As used herein, a “gaming device” should be understood to be any one of a general purpose computer, as for example a personal computer or a laptop computer, a client computer configured for interaction with a server, a special purpose computer such as a server, or a smart phone, soft phone, tablet computer, personal digital assistant or any other machine adapted for executing programmable instructions in accordance with the description thereof set forth above.

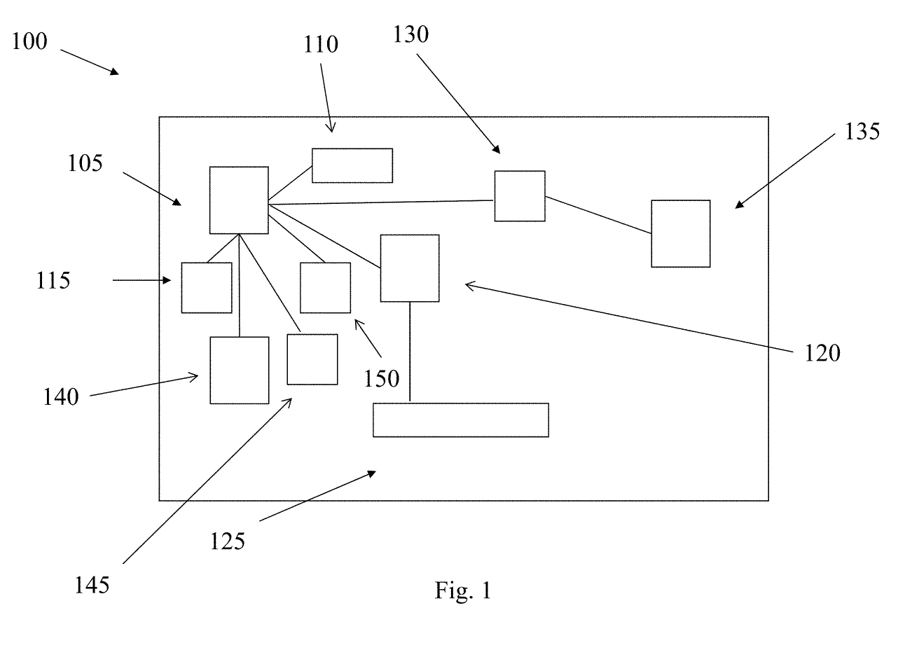

The embodiments of the present invention may be facilitated by an electronic gaming device whereby a single player plays against the electronic gaming device's processor as described herein. The electronic gaming device may be a standalone device and bar-top device forming part of a gaming device network or not. A block diagram of the electronic gaming device 100 is shown in FIG. 1. The exemplary electronic gaming device 100 may include a central processing unit (CPU) also deemed a processor 105 which controls the electronic gaming device 100 based on instructions stored in program read-only memory (ROM) 110 and pay table ROM 115. Program ROM 110 stores executable instructions related to the operation of the gaming device 100 and which are generally permanent. CPU 105 may be connected to a video controller 120 which provides output to one or more video displays 125. Similarly, an audio controller 130 provides audio output as dictated by the CPU 105 through speakers 135. The aforementioned components, and others, may be attached to a circuit board forming a motherboard. In another embodiment, the electronic gaming device 100 may be linked to a central game server which allows players to select from a number of games via the electronic gaming device 100. In such an embodiment, one or more processors integrated into the central server control the gaming device 100 based on instructions stored in program ROM 110.

A user interface 140 may respond to buttons on button panel or display incorporating touch screen technology or any other devices providing means for users to communicate with, and instruct, the electronic gaming device 100. Wager memory 145 stores an amount of money/credits deposited into the electronic gaming device 100 by a player and specific wager information related to each play of the electronic gaming device 100. Payout system 150 includes a coupon printer or similar device for receiving money/coupon from the electronic gaming device 100.

Those skilled in the art will recognize that the configuration and features of the electronic gaming device 100 disclosed herein are exemplary and may be altered in any number of ways without impacting the embodiments of the present invention.

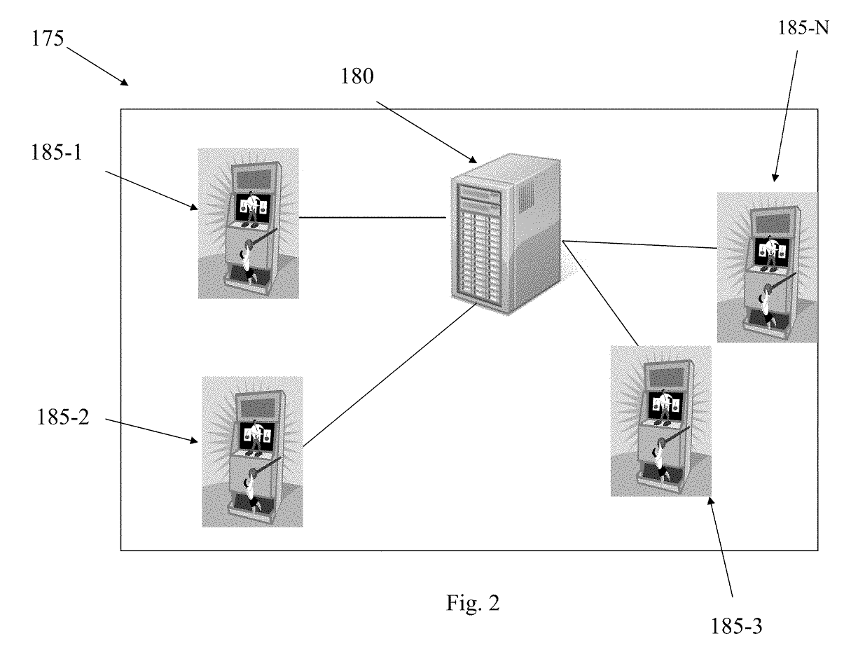

FIG. 2 shows a block diagram of a gaming network 175 which may be used to facilitate play of the game via linked gaming devices according to the embodiments of the present invention. The gaming network 175 comprises a central processor 180 (e.g., processor-equipped game server) in communication with multiple gaming devices 185-1 through 185-N as described in FIG. 1.

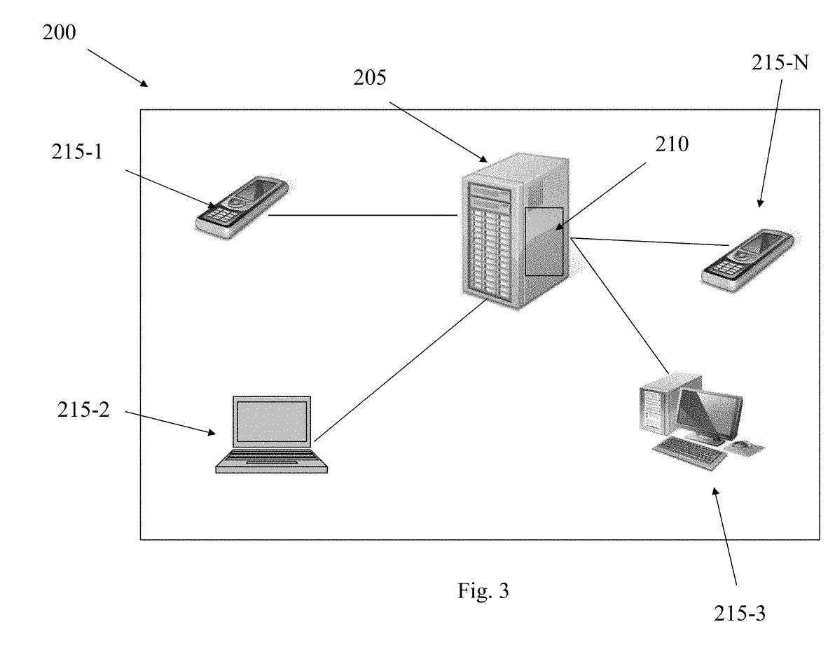

FIG. 3 shows a block diagram of a wireless system 200 which may be used to facilitate remote play of the game according to the embodiments of the present invention. The wireless network system 200 comprises a processor-equipped game server 205, including one or more processors 210 running game software, and remote devices 215-1 through 215-N (e.g., smart phones) configured to access said game server 205 facilitating game play on the remote devices 215-1 through 215-N. In another embodiment, the video game according to the embodiments of the present invention may be in the form of a software application (“App”) downloadable onto smart phones, tablets or computers and playable via processing power and a user interface associated therewith.

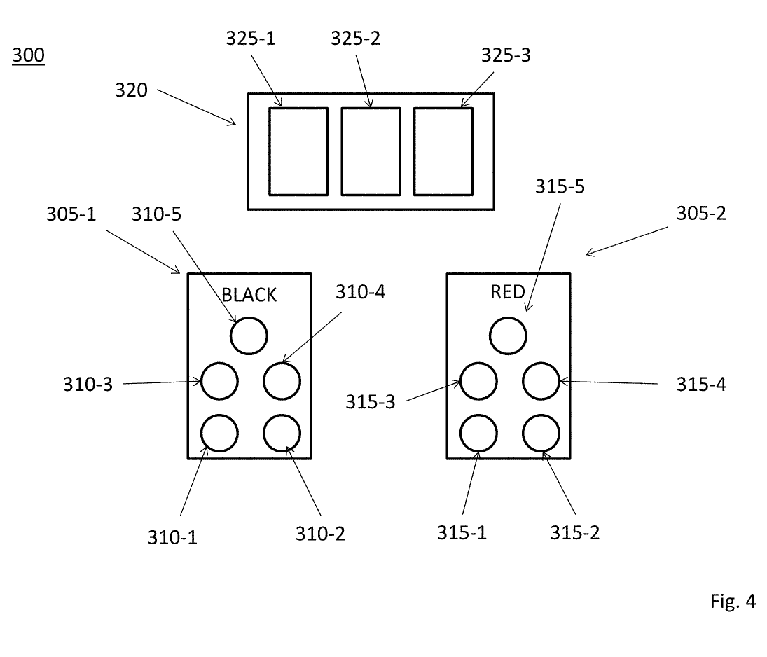

FIG. 4 illustrates an exemplary player wager area 300 of the type depicted on a table layout or display of a gaming device according to the embodiments of the present invention. FIG. 4 shows the layout 300 depicting a first player wager area 305-1 related to black suits (e.g., Spades and Clubs) and a second player wager area 305-2 for red suits (e.g., Diamonds and Hearts). The first player wager area depicts a mandatory 9-card wager area 310-1, play wager area 310-2, optional 3-card wager area 310-3, optional 6-card wager area 310-4 and optional 9-card bonus wager area 310-5. The second player wager area depicts a mandatory 9-card wager area 315-1, play wager area 315-2, optional 3-card wager area 315-3, optional 6-card wager area 315-4 and optional 9-card bonus wager area 315-5. A community card area 320, comprising three community card placements areas 325-1 through 325-3, is depicted near a center of the table layout 300.

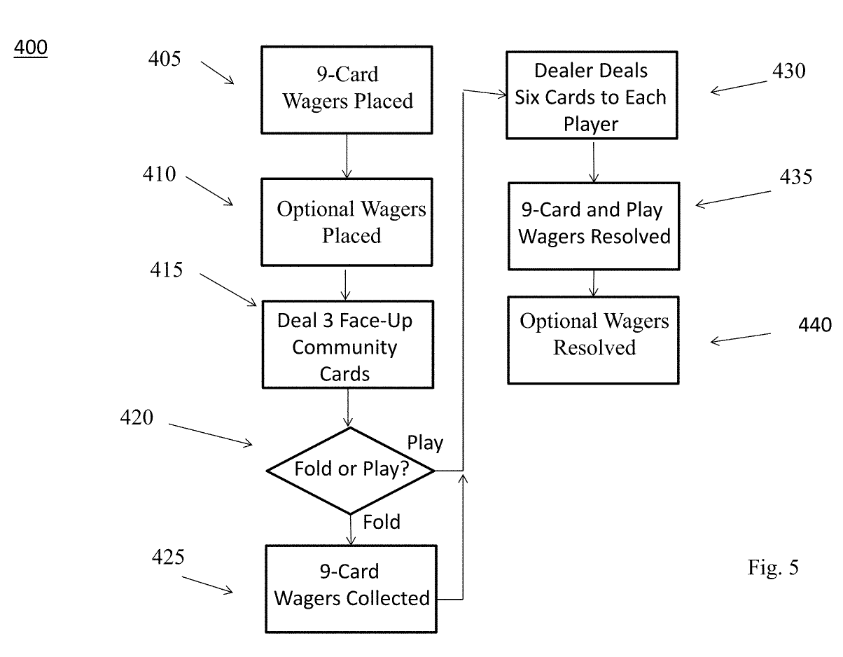

FIG. 5 shows a flow chart 400 detailing a method conducting a live casino game according to the embodiments of the present invention. At 405, players place a mandatory 9-card wager by placing chips on one of the mandatory 9-card wager areas 310-1 or 315-1 based on black suits or red suits, respectively. At 410, players may place optional 3-card wagers, 6-card wagers and 9-card bonus wagers on the 3-card wager area 310-3, 315-3, 6-card wager area 310-4, 315-4 and 9-card bonus wager area 310-5, 315-5, respectively, each corresponding to the suit color of the mandatory 9-card wager. That is, if the player places a mandatory 9-card wager on black suits, any optional wagers are on the black suits as well. Players may make none, one, two or all of the optional wagers commensurate with the suit color of the mandatory 9-card wager. At 415, a dealer deals three face-up community cards from one or more standard decks of fifty-two playing cards. The standard deck comprises ranks of 2 through 10, Jack, Queen, King and Ace associated with suits of Spades, Clubs, Diamonds and Hearts. At 420, each player has the option to fold or place a play wager in play wager area 310-2, 315-2 dependent on the color selected with the mandatory 9-card wager and equal to the mandatory 9-card wager. If a player folds, at 425, the house or operator collects the player's 9-card wager while the optional 3-card wager, 6-card wager and 9-card bonus wager remain active. If no optional wagers are placed and the player folds, the house may elect to deal 6 player cards or skip the player. At 430, the dealer deals each player six cards. At 435, the dealer resolves each player's mandatory 9-card wager and play wager according to a pre-established pay table. In one embodiment, the mandatory 9-card wager and play wager are paid as set forth in Table 1. As set forth in Table 1, each player's six cards are combined with the three community cards to determine how many cards of the same suit in the selected color the player holds. If the player selects black, the dealer evaluates whether the player holds at least a 3-card in Spades or Clubs whereas if the player selects red, the dealer evaluates whether the player holds at least a 3-card flush in Hearts or Diamonds.

TABLE 1
(9-Card and Play Wagers Pay Table)

| Player Hand | Payout |
|---|---|
| Four or More Card Flush in Suit | Even Money (1 to 1) |
| Color Selected by Player | |
| Three Card Flush in Suit Color | Push |
| Selected by Player | |
| Less than Three Card Flush in Suit | Loss |
| Color Selected by Player | |

At 440, the dealer evaluates the optional 3-card wager, 6-card wager and 9-card bonus wager based on a pay table. Pay tables 2, 3 and 4 show exemplary payouts for the optional 3-card wager, 6-card wager and 9-card bonus wager.

TABLE 2
(3-Card Optional Wager Pay Table)

| Player Hand | Payout |
|---|---|
| 3-Card Flush Suit Color Selected by | 5 to 1 |
| Player | |
| 2-card Flush in Suit Color Selected | 2 to 1 |
| by Player | |
| Other | Loss |

TABLE 3
(6-Card Optional Wager Pay Table)

| Player Hand | Payout |
|---|---|
| 4, 5 and 6-Card Flush Suit Color | 3 to 1 |
| Selected by Player | |
| 3-card Flush in Suit Color Selected | 2 to 1 |
| by Player | |
| Other | Loss |

TABLE 4
(Optional 9-Card Bonus Wager Pay Table)

| Player Hand | Payout |
|---|---|
| 9-Card Flush | 1000 to 1 |
| 8-Card Flush | 500 to 1 |
| 7-Card Flush | 200 to 1 |
| 6-Card Flush | 20 to 1 |
| 5-Card Flush | 10 to 1 |
| Other | Loss |

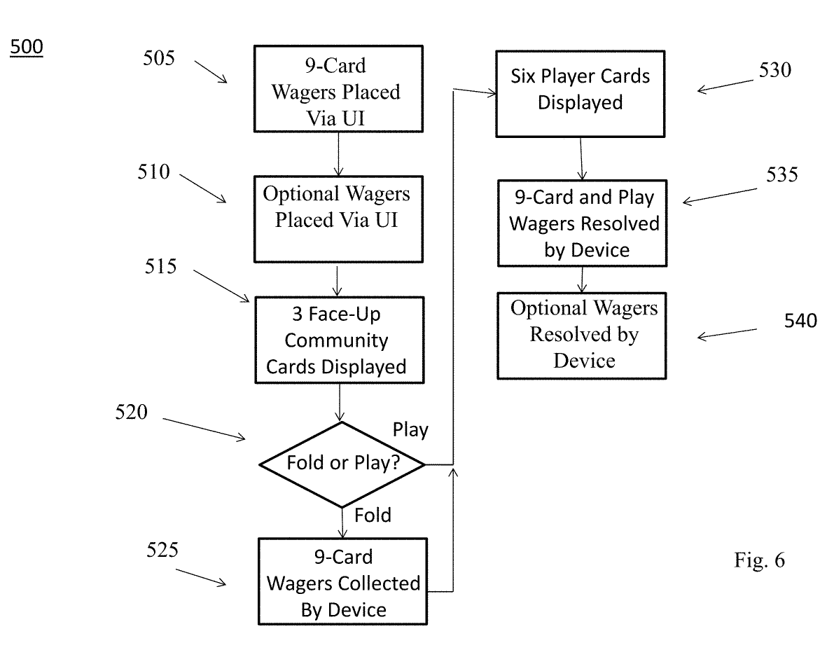

FIG. 6 shows a flow chart 500 detailing a method conducting an electronic casino game according to the embodiments of the present invention. In this instance, the gaming device permits a single player to play against the gaming device. In other embodiments, multiple players may play against the house at a common table accessed by multiple gaming devices (akin to poker). At 505, a player places a mandatory 9-card wager on red or black by utilizing a user interface (e.g., touch screen or buttons). The wager may be in the form of deposited cash or coupons or credits on the gaming device. At 510, players may place optional 3-card wagers, 6-card wagers and the 9-card bonus wagers utilizing the user interface. At 515, the gaming device processor causes three face-up community cards from one or more simulated standard decks of fifty-two playing cards to be displayed. At 520, the player has the option to fold or place a play wager utilizing the user interface dependent on the color selected with the mandatory 9-card wager and equal to the mandatory 9-card wager. If a player folds, at 525, the gaming device collects the player's mandatory 9-card wager while the optional 3-card wagers, 6-card wagers and the 9-card bonus wagers remain active. At 530, the gaming device processor causes six player cards to be displayed. At 535, the gaming device processor resolves the player's mandatory 9-card wager and play wager according to a pre-established pay table. The player's six cards are combined with the three community cards to determine how many cards of the same suit in the selected color the player holds. If the player selects black, the gaming device processor evaluates whether the player holds at least a 3-card flush in Spades or Clubs whereas if the player selects red, the gaming device processor evaluates whether the player holds at least a 3-card flush in Hearts or Diamonds. At 540, the dealer evaluates the optional 3-card wagers, 6-card wagers and the 9-card bonus wagers based on a pay table.

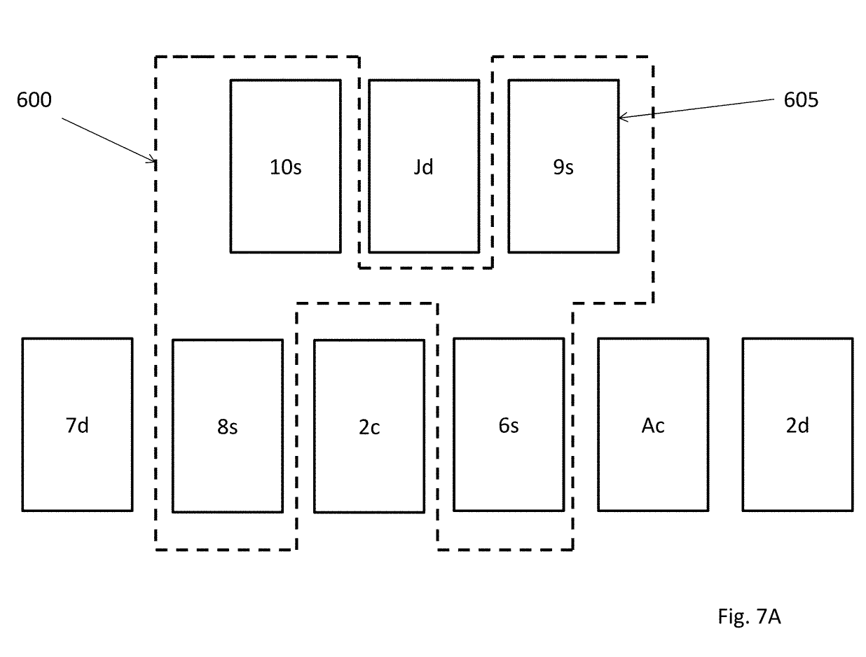

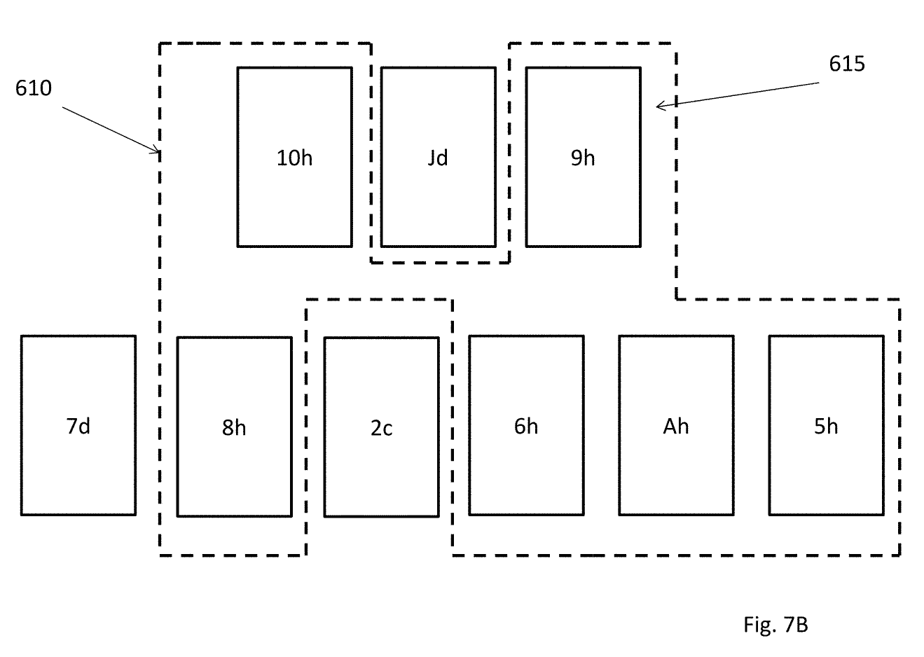

FIG. 7A shows three community cards and six player cards including a 4-card Spade flush 600 comprising the 6 of Spades, 8 of Spades, 9 of Spades and 10 of Spades which, assuming a black suit selection, results in winning mandatory 9-card wagers and play wagers. Also, the optional 3-card wager would be a winner as the three community cards 605 comprise two Spades. According to Table 2, the two Spades included in the three community cards result in a 2 to 1 payout. FIG. 7B shows three community cards 615 and six player cards which show a 6-card heart flush 610 comprising the 2 of Hearts, 6 of Hearts, 8 of Hearts, 9 of Hearts, 10 of Hearts and Ace of Hearts which would, assuming a red suit selection, result in winning mandatory 9-card wagers and play wagers. Also, the optional 3-card wager, 6-card wager and the 9-card bonus wager would be winners as the three community cards 610 comprise two Hearts, the six player cards include four Hearts and the combined nine cards include six Hearts. According to Tables 2, 3 and 4, the two Hearts in the three community cards results in a 2 to 1 payout, the four Hearts in the six player cards results in a 3 to 1 payout and the six Hearts in the nine cards results in a 20 to 1 payout, respectively. A 1 to 1 payout is also paid for the mandatory 9-card wager.

There are 132,600 unique 3-card hands possible with a deck of fifty-two playing cards; there are 20,358,520 unique 6-card hands possible with a deck of fifty-two playing cards and 3,679,075,400 unique 9-card hands possible with a deck of fifty-two playing cards. Accordingly, to generate truly random outcomes, it is necessary to use playing cards or electronic/computer-based random number generators. Human beings are not capable of generating truly random outcomes because of inherent biases and the numbers, as referenced above, are simply too large. Playing cards and computer-based random number generators are able to quickly (e.g., nanoseconds (computer) to seconds (playing cards)) generate large numbers of truly random outcomes to facilitate the necessary outcomes. Moreover, the outcomes permit a suitable house advantage (e.g., 1%-10%) to be created such that the casino game is attractive to players and profitable to the casino operators. For example, a gaming machine or device processor may be configured to generate thousands or tens of thousands of random numbers or outcomes or hands or combinations per second. The generation of such random numbers or outcomes or hands or combinations, in such vast quantities, is not possible by human beings. Indeed, human beings are not capable of generating truly random outcomes in any quantity as personal biases come into play.

While certain pay tables are shown herein, those skilled in the art will recognize that other pay tables are within the spirit and scope of the present invention.

Although the invention has been described in detail with reference to several embodiments, additional variations and modifications exist within the scope and spirit of the invention as described and defined in the following claims.

We claim:

1. A gaming system comprising:
a dealer;
game chips;
a gaming table supporting a game layout, said game layout including multiple player areas, said multiple player areas including a plurality of wager placement areas thereon;
a community card area;
one or more decks of playing cards, said one or more decks of playing cards comprising fifty-two cards including ranks of 2 through 10, Jack, Queen, King and Ace associated with suits of Spades, Clubs, Diamonds and Hearts; and
wherein said dealer is instructed to:
(i) accept a mandatory 9-card wager based on a selected suit color and an aggregate number of corresponding same-suited cards within three community cards in combination with six player's cards; (ii) deal three community cards; (iii) accept a play wager or forfeiture of said mandatory 9-card wager; (iv) deal six player's cards to each player, said three community cards in combination with said six player's cards forming one of a possible at least one billion possible nine-card combinations; and (v) resolve said mandatory 9-card wager based on pre-established payouts associated with said aggregate number of same-suited cards of said selected suit color within said combined nine cards.

2. The gaming system of claim 1 wherein said dealer is further instructed to accept optional 3-card wagers, 6-card wagers and/or 9-card bonus wagers premised on a number of same-suited cards of said selected suit color within said three community cards, six player's cards and nine combined cards, respectively.

3. The gaming system of claim 1 wherein said suit color is selected between red corresponding to Diamonds and Hearts and black corresponding to Spades and Clubs.

4. A gaming network comprising:
at least one central processor configured to run a casino game, said central processor in communication with one or more gaming devices, each of said one or more gaming devices including a display and user interface, memory in communication with said at least one processor; and
wherein said central processor is configured to conduct said casino game utilizing one or more decks of simulated playing cards, said one or more decks of simulated playing cards comprising fifty-two cards including ranks of 2 through 10, Jack, Queen, King and Ace associated with suits of Spades, Clubs, Diamonds and Hearts wherein one suit of said playing cards further include theme numeric indicia; and
wherein said central processor is further configured to: (i) via a user interface on each participating gaming device, accept a mandatory 9-card wager based on a selected suit color and an aggregate number of corresponding same-suited cards within three community cards in combination with six player's cards; (ii) display three community cards on displays of participating gaming devices; (iii) via said user interface, accept a play wager or forfeiture of said mandatory 9-card wager; (iv) display on displays of participating gaming devices, six player's cards which in combination with said three community cards form one of a possible at least one billion possible nine-card combinations; and (v) via stored payout data, resolve said mandatory 9-card wagers based on pre-established payouts associated with said aggregate of said same-suited cards within said combined nine cards.

5. The gaming network of claim 4 wherein said processor is further configured to accept optional 3-card wagers, 6-card wagers and/or 9-card bonus wagers premised on a number of same-suited cards of said selected suit color within said three community cards, six player's cards and nine combined cards, respectively.

6. The gaming network of claim 4 wherein said suit color is selected between red corresponding to Diamonds and Hearts and black corresponding to Spades and Clubs.

7. A gaming device comprising:
at least one processor configured to run a casino game;
a display;
a user interface;
memory in communication with said at least one processor; and
wherein said processor is configured to conduct said casino game utilizing one or more decks of simulated playing cards, said one or more decks of simulated playing cards comprising fifty-two cards including ranks of 2 through 10, Jack, Queen, King and Ace associated with suits of Spades, Clubs, Diamonds and Hearts wherein one suit further includes numeric indicia; and
wherein said processor is further configured to: (i) via a user interface on each participating gaming device, accept a mandatory 9-card wager based on a selected suit color and an aggregate number of corresponding same-suited cards within three community cards in combination with six player's cards; (ii) display three community cards on displays of participating gaming devices; (iii) via said user interface, accept a play wager or forfeiture of said mandatory 9-card wager; (iv) display on displays of participating gaming devices, six player's cards which in combination with said three community cards form one of a possible at least one billion possible nine-card combinations; and (v) via stored payout data, resolve said mandatory 9-card wagers based on pre-established payouts associated with said aggregate of said same-suited cards within said combined nine cards.

8. The gaming device of claim 7 wherein said processor is further configured to accept optional 3-card wagers, 6-card wagers and/or 9-card bonus wagers premised on a number of same-suited cards of said selected suit color within said three community cards, six player's cards and nine combined cards, respectively.

9. The gaming device of claim 7 wherein said suit color is selected between red corresponding to Diamonds and Hearts and black corresponding to Spades and Clubs.
